(19) United States
(12) Patent Application Publication
(10) Pub. No.: US 2012/0198353 A1
(43) Pub. Date: Aug. 2, 2012

(54) TRANSFERRING DATA USING A PHYSICAL GESTURE

(75) Inventors: Tricia Lee, Kirkland, WA (US); Stacey Law, Redmond, WA (US)

(73) Assignee: MICROSOFT CORPORATION, Redmond, WA (US)

(21) Appl. No.: 13/015,858

(22) Filed: Jan. 28, 2011

(51) Int. Cl. G06F 3/01

(52) U.S. Cl. 715/748

(57) ABSTRACT

A system and method for making the transfer of data within a networked computing environment more intuitive is described. In one aspect, the disclosed technology performs a data transfer from an origin device to one or more target devices in response to one or more physical gestures. In some embodiments, the one or more physical gestures may include the physical action of shaking and/or pointing the origin device for the data transfer in the direction of a target device or an image associated with a target device. In some embodiments, a user of an origin device may initiate an indirect data transfer from the origin device to a target device by performing a particular physical gesture in the direction of an image associated with the target device. An indirect data transfer is one where the origin device utilizes an intermediary device in order to transmit data to one or more target devices.

### BACKGROUND

In a typical computing environment, a user may initiate a data transfer (e.g., transmitting data from one computing device to another) by typing commands into a command line interface or performing a “drag and drop” action using a graphical user interface. The user may perform a “drag and drop” action by opening a directory window associated with the data to be transferred, opening a directory window associated with a target destination, selecting the data to be transferred such as one or more files or folders, and dragging the selected data between the two windows. The opening of windows and the selection of data is commonly performed through the use of an input device such as a keyboard or mouse. The use of such interfaces can be confusing or less intuitive with respect transferring data between different computing devices.

### SUMMARY

Technology is described for controlling the transfer of data from an origin device to one or more target devices in response to one or more physical gestures. In some embodiments, the one or more physical gestures may include the physical action of shaking and/or pointing the origin device for the data transfer in the direction of a target device or an image associated with a target device. In some embodiments, a user of an origin device may initiate an indirect data transfer from the origin device to a target device by performing a particular physical gesture in the direction of an image associated with the target device. An indirect data transfer is one where the origin device utilizes an intermediary device in order to transmit data to one or more target devices.

One embodiment includes associating a particular type of data transfer with a particular physical gesture that includes a physical motion of an origin computing device, identifying one or more files to be transferred from the origin computing device, automatically detecting the particular physical gesture, determining the particular type of data transfer based on the step of automatically detecting and the step of associating, automatically determining one or more target computing devices including automatically determining a direction of motion associated with the physical motion of the origin computing device, and transferring the one or more files to the one or more target computing devices.

One embodiment includes a depth sensing camera and one or more processors. The depth sensing camera captures a first depth image including an image of an origin computing device. The one or more processors are in communication with the depth sensing camera. The one or more processors determine a direction of motion associated with the origin computing device and identify a selected target representation in the direction of motion. The one or more processors receive one or more files from the origin computing device and transfer the one or more files to a particular target device associated with the selected target representation.

One embodiment includes identifying one or more files to be transferred from an origin computing device, automatically detecting a particular physical gesture including a physical motion of the origin computing device, determining the particular type of data transfer based on the step of automatically detecting, automatically determining one or more target computing devices, and transferring the one or more files to the one or more target computing devices. The step of automatically determining one or more target computing devices includes automatically determining a direction of motion associated with the physical motion of the origin computing device and automatically identifying a selected target representation in the direction of motion. The selected target representation is associated with a profile that includes contact information for the one or more target computing devices, the contact information includes at least one electronic address.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one embodiment of a networked computing environment.

FIG. 2A depicts one embodiment of a networked computing environment.

FIG. 2B depicts one embodiment of a target detection and tracking system.

FIG. 3 is a flowchart describing one embodiment of a process for performing a data transfer from an origin device to one or more target devices in response to one or more physical gestures.

FIG. 4A is a flowchart describing one embodiment of a process for determining one or more target devices in preparation for a direct data transfer.

FIG. 4B is a flowchart describing one embodiment of a process for determining one or more target devices in preparation for an indirect data transfer.

FIG. 5A is a flowchart describing one embodiment of a process for detecting a particular physical gesture.

FIG. 5B is a flowchart describing one embodiment of a process for automatically pairing one or more computing devices.

FIG. 6 depicts one embodiment of an indirect data transfer to a particular target device.

FIG. 7 depicts one embodiment of a gaming and media system.

FIG. 8 is a block diagram of an embodiment of a gaming and media system.

FIG. 9 is a block diagram of an embodiment of a mobile device.

FIG. 10 is a block diagram of an embodiment of a computing system environment.

### DETAILED DESCRIPTION

Technology is described for controlling the transfer of data from an origin device to one or more target devices in response to one or more physical gestures. In some embodiments, the one or more physical gestures may include the physical action of shaking and/or pointing the origin device for the data transfer in the direction of a target device or an image associated with a target device. In some embodiments, a user of an origin device may initiate an indirect data transfer from the origin device to a target device by performing a particular physical gesture in the direction of an image associated with the target device. An indirect data transfer is one where the origin device utilizes an intermediary device in order to transmit data to one or more target devices.

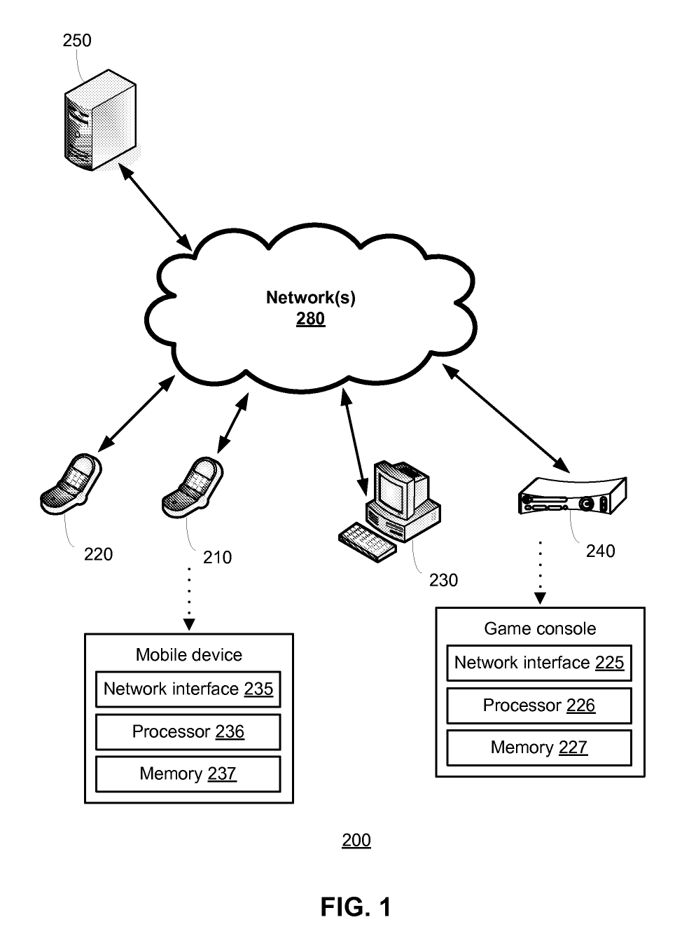

FIG. 1 is a block diagram of one embodiment of a networked computing environment 200 in which the disclosed technology may be practiced. Networked computing environment 200 includes a plurality of computing devices interconnected through one or more networks 280. The one or more networks 280 allow a particular computing device to connect to and communicate with another computing device. The depicted computing devices include game console 240, mobile devices 220 and 210, desktop computer 230, and application server 250. In some embodiments, the plurality of computing devices may include other computing devices not shown. In some embodiments, the plurality of computing devices may include more than or less than the number of computing devices shown in FIG. 1. The one or more networks 280 may include a secure network such as an enterprise private network, an unsecure network such as a wireless open network, a local area network (LAN), a wide area network (WAN), and the Internet. Each network of the one or more networks 280 may include hubs, bridges, routers, switches, and wired transmission media such as a wired network or direct-wired connection.

An application server, such as application server 250, may allow a client to play content (e.g., audio, image, video, and gaming files) from the application server or to download content and/or application related data from the application server. In one example, a client may download a user profile associated with an application user or a gaming profile associated with a game player. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of game console 240 includes a network interface 225, processor 226, and memory 227, all in communication with each other. Network interface 225 allows game console 240 to connect to one or more networks 280. Network interface 225 may include a wireless network interface, a modem, and/or a wired network interface. Processor 226 allows game console 240 to execute computer readable instructions stored in memory 227 to perform the processes discussed herein.

One embodiment of mobile device 210 includes a network interface 235, processor 236, and memory 237, all in communication with each other. Network interface 235 allows mobile device 210 to connect to one or more networks 280. Network interface 235 may include a wireless network interface, a modem, and/or a wired network interface. Processor 236 allows mobile device 210 to execute computer readable instructions stored in memory 237 to perform the processes discussed herein.

Networked computing environment 200 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer network diagrams to depict the Internet as an abstraction of the underlying infrastructure it represents.

In one embodiment, a user of an origin device (i.e., the source for the data being transferred) performs a physical action in order to initiate a data transfer from the origin device to a target device. Any one of the computing devices of FIG. 1 can be an origin device or a target device. A data transfer may involve moving data (i.e., deleting data on the origin device after the data transfer) or copying data (i.e., not deleting data on the origin device) to the target device. In one example, a user of mobile device 210 initiates a data transfer from mobile device 210 by performing a physical action with the mobile device. The physical action may include shaking the mobile device in a particular way and/or pointing the mobile device in the direction of a target device. After the physical action is performed, mobile device 210 may sense the physical action, determine the direction of the physical action, locate one or more target computing devices in the direction of the physical action, and transmit data directly to the one or more target computing devices.

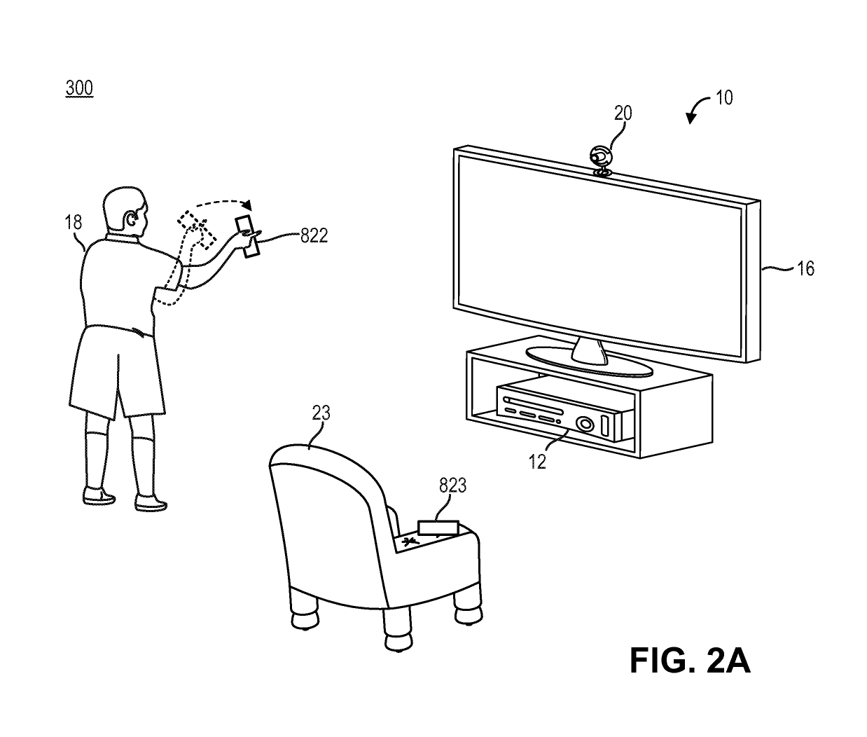

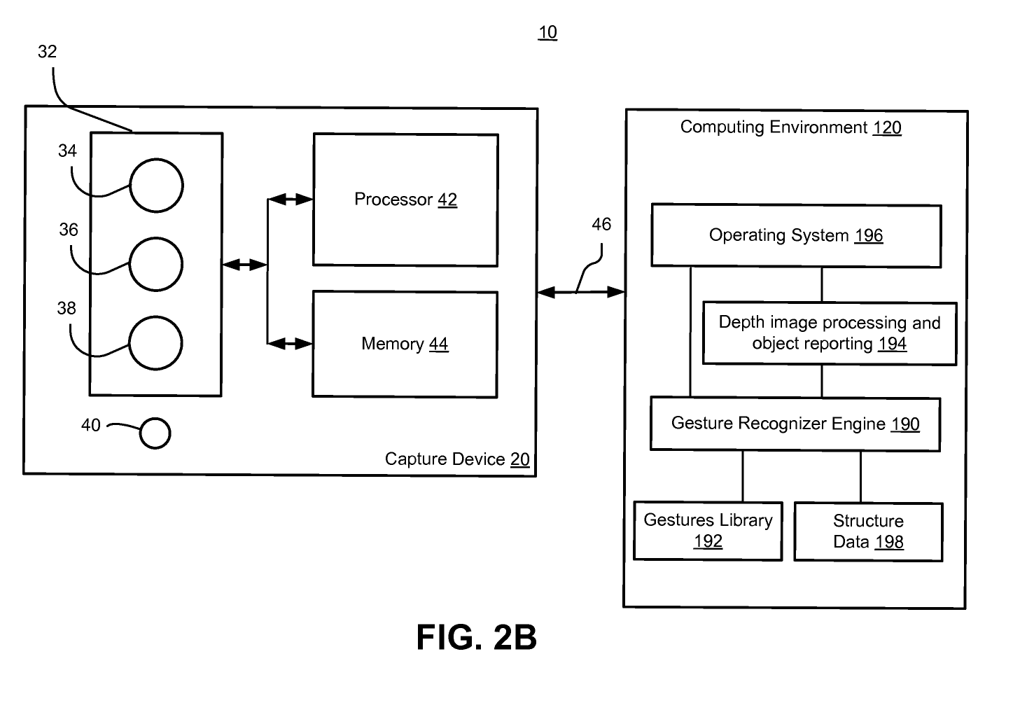

FIG. 2A depicts one embodiment of a networked computing environment 300. Networked computing environment 300 includes mobile devices 822 and 823, and a target detection and tracking system 10. Target detection and tracking system 10 includes gaming console 12 and capture device 20. Capture device 20 may include a depth sensing camera that may be used to visually monitor one or more targets including one or more users, such as user 18, and one or more objects, such as mobile devices 822 and 823 and chair 23. In one example, mobile devices 822 and 823 correspond to mobile devices 210 and 220 in FIG. 1 and gaming console 12 corresponds to game console 240 in FIG. 1. In one embodiment, target detection and tracking system 10 includes one or more processors in communication with a depth sensing camera.

Suitable examples of target detection and tracking systems and components thereof are found in the following co-pending patent applications, all of which are herein incorporated by reference in their entirety: U.S. patent application Ser. No. 12/475,094, entitled “Environment And/Or Target Segmentation,” filed May 29, 2009; U.S. patent application Ser. No. 12/511,850, entitled “Auto Generating a Visual Representation,” filed Jul. 29, 2009; U.S. patent application Ser. No. 12/474,655, entitled “Gesture Tool,” filed May 29, 2009; U.S. patent application Ser. No. 12/603,437, entitled “Pose Tracking Pipeline,” filed Oct. 21, 2009; U.S. patent application Ser. No. 12/475,308, entitled “Device for Identifying and Tracking Multiple Humans Over Time,” filed May 29, 2009, U.S. patent application Ser. No. 12/575,388, entitled “Human Tracking System,” filed Oct. 7, 2009; U.S. patent application Ser. No. 12/422,661, entitled “Gesture Recognizer System Architecture,” filed Apr. 13, 2009; and U.S. patent application Ser. No. 12/391,150, entitled “Standard Gestures,” filed Feb. 23, 2009.

In one embodiment, mobile device 822 may be an active object. Active objects may include one or more sensors to obtain information such as acceleration, position, motion, and/or orientation information. The one or more sensors may include motion sensors (e.g., accelerometers), rotation sensors (e.g., gyroscopes), and other motion-sensing devices. In one example, the one or more sensors may include a MEMS accelerometer and/or a piezoelectric sensor. In another example, mobile device 822 includes an accelerometer, a magnetometer, and a gyroscope and generates acceleration, magnetic field, and orientation information associated with movement of the mobile device.

A user may create gestures by moving his or her body. A gesture may comprise a motion or pose by a user that may be captured as image data, including depth image data, and parsed for meaning. Gestures may be dynamic or static. A dynamic gesture is one comprising a motion, such as mimicking throwing a ball. A static gesture may include a static pose, such as holding one's forearms crossed. A gesture may also incorporate objects, such as a mobile device or other portable computing device.

By utilizing an active object and/or a capture device, gestures (including poses) performed by one or more users may be captured, analyzed, and tracked in order to control aspects of an operating system or computing application. In one example, user 18 may initiate a data transfer between mobile devices 822 and 823 by shaking and pointing mobile device 822 in the direction of mobile device 823. In another example, both visual tracking information obtained from capture device 20 and acceleration and/or orientation information from mobile device 822 is used to determine what kind of data transfer to perform and to which of one or more target devices to transmit the data.

In one embodiment, capture device 20 may capture image and audio data relating to one or more users and/or objects. For example, capture device 20 may be used to capture information relating to partial or full body movements, gestures, and speech of one or more users. The information captured by capture device 20 may be received by gaming console 12 and/or a processing element within capture device 20 and used to render, interact with, and control aspects of a gaming application or other computing application. In one example, capture device 20 captures image and audio data relating to a particular user and processes the captured information to identify the particular user by executing facial and voice recognition software.

In one embodiment, the gaming console 12 and/or capture device 20 may be connected to an audiovisual device 16 such as a television, a monitor, a high-definition television (HDTV), or the like that may provide game or application visuals and/or audio to a user such as user 18. In one example, the gaming console 12 may include a video adapter such as a graphics card and/or an audio adapter such as a sound card that may provide audiovisual signals associated with a game application, non-game application, or the like. The audiovisual device 16 may receive the audiovisual signals from the gaming console 12 and may output the game or application visuals and/or audio associated with the audiovisual signals to the user 18. In one embodiment, the audiovisual device 16 may be connected to the gaming console 12 via, for example, an S-Video cable, a coaxial cable, an HDMI cable, a DVI cable, a VGA cable, or the like.

FIG. 2B illustrates one embodiment of a target detection and tracking system 10 including a capture device 20 and computing environment 120 that may be used to recognize human and non-human targets in a capture area (with or without special sensing devices attached to the subjects), uniquely identify them, and track them in three dimensional space. In one example, computing environment 120 corresponds with gaming console 12 in FIG. 2A.

In one embodiment, the capture device 20 may be a depth camera (or depth sensing camera) configured to capture video with depth information including a depth image that may include depth values via any suitable technique including, for example, time-of-flight, structured light, stereo image, or the like. In one embodiment, the capture device 20 may include a depth sensing image sensor. In some embodiments, the capture device 20 may organize the calculated depth information into “Z layers,” or layers that may be perpendicular to a Z-axis extending from the depth camera along its line of sight.

The capture device 20 may include an image camera component 32. In one embodiment, the image camera component 32 may be a depth camera that may capture a depth image of a scene. The depth image may include a two-dimensional (2-D) pixel area of the captured scene where each pixel in the 2-D pixel area may represent a depth value such as a distance in, for example, centimeters, millimeters, or the like of an object in the captured scene from the camera.

The image camera component 32 may include an IR light component 34, a three-dimensional (3-D) camera 36, and an RGB camera 38 that may be used to capture the depth image of a capture area. For example, in time-of-flight analysis, the IR light component 34 of the capture device 20 may emit an infrared light onto the capture area and may then use sensors to detect the backscattered light from the surface of one or more targets and objects in the capture area using, for example, the 3-D camera 36 and/or the RGB camera 38. In some embodiment, capture device 20 may include an IR CMOS image sensor. In some embodiments, pulsed infrared light may be used such that the time between an outgoing light pulse and a corresponding incoming light pulse may be measured and used to determine a physical distance from the capture device 20 to a particular location on the targets or objects in the capture area. Additionally, the phase of the outgoing light wave may be compared to the phase of the incoming light wave to determine a phase shift. The phase shift may then be used to determine a physical distance from the capture device to a particular location on the targets or objects.

In one embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example, the capture device 20 may use structured light to capture depth information. In such an analysis, patterned light (i.e., light displayed as a known pattern such as grid pattern or a stripe pattern) may be projected onto the capture area via, for example, the IR light component 34. Upon striking the surface of one or more targets (or objects) in the capture area, the pattern may become deformed in response. Such a deformation of the pattern may be captured by, for example, the 3-D camera 36 and/or the RGB camera 38 and analyzed to determine a physical distance from the capture device to a particular location on the targets or objects.

In some embodiments, two or more different cameras may be incorporated into an integrated capture device. For example, a depth camera and a video camera (e.g., an RGB video camera) may be incorporated into a common capture device. In some embodiments, two or more separate capture devices may be cooperatively used. For example, a depth camera and a separate video camera may be used. When a video camera is used, it may be used to provide target tracking data, confirmation data for error correction of target tracking, image capture, face recognition, high-precision tracking of fingers (or other small features), light sensing, and/or other functions.

In one embodiment, the capture device 20 may include two or more physically separated cameras that may view a capture area from different angles to obtain visual stereo data that may be resolved to generate depth information. Depth may also be determined by capturing images using a plurality of detectors that may be monochromatic, infrared, RGB, or any other type of detector and performing a parallax calculation. Other types of depth image sensors can also be used to create a depth image.

As shown in FIG. 2B, capture device 20 may include a microphone 40. The microphone 40 may include a transducer or sensor that may receive and convert sound into an electrical signal. In one embodiment, the microphone 40 may be used to reduce feedback between the capture device 20 and the computing environment 120 in the target detection and tracking system 10. Additionally, the microphone 40 may be used to receive audio signals that may also be provided by the user to control applications such as game applications, non-game applications, or the like that may be executed by the computing environment 120.

In one embodiment, the capture device 20 may include a processor 42 that may be in operative communication with the image camera component 32. The processor 42 may include a standardized processor, a specialized processor, a microprocessor, or the like. The processor 42 may execute instructions that may include instructions for storing profiles, receiving the depth image, determining whether a suitable target may be included in the depth image, converting the suitable target into a skeletal representation or model of the target, or any other suitable instructions.

It is to be understood that at least some target analysis and tracking operations may be executed by processors contained within one or more capture devices such as capture device 20. A capture device may include one or more onboard processing units configured to perform one or more target analysis and/or tracking functions. Moreover, a capture device may include firmware to facilitate updating such onboard processing logic.

The capture device 20 may include a memory component 44 that may store the instructions that may be executed by the processor 42, images or frames of images captured by the 3-D camera or RGB camera, user profiles or any other suitable information, images, or the like. In one example, the memory component 44 may include random access memory (RAM), read only memory (ROM), cache, Flash memory, a hard disk, or any other suitable storage component. As shown in FIG. 2B, the memory component 44 may be a separate component in communication with the image capture component 32 and the processor 42. In another embodiment, the memory component 44 may be integrated into the processor 42 and/or the image capture component 32. In one embodiment, some or all of the components 32, 34, 36, 38, 40, 42 and 44 of the capture device 20 illustrated in FIG. 2B are housed in a single housing.

The capture device 20 may be in communication with the computing environment 120 via a communication link 46. The communication link 46 may be a wired connection including, for example, a USB connection, a FireWire connection, an Ethernet cable connection, or the like and/or a wireless connection such as a wireless 802.11b, g, a, or n connection. The computing environment 120 may provide a clock to the capture device 20 that may be used to determine when to capture, for example, a scene via the communication link 46.

In one embodiment, the capture device 20 may provide the depth information and images captured by, for example, the 3-D camera 36 and/or the RGB camera 38 to the computing environment 120 via the communication link 46. The computing environment 120 may then use the depth information and captured images to, for example, create a virtual screen, adapt the user interface, and control an application such as a game or word processor.

As shown in FIG. 2B, computing environment 120 includes gestures library 192, structure data 198, gesture recognition engine 190, depth image processing and object reporting module 194, and operating system 196. Depth image processing and object reporting module 194 uses the depth images to track the motion of objects, such as the user and other objects. To assist in the tracking of the objects, depth image processing and object reporting module 194 uses gestures library 190, structure data 198, and gesture recognition engine 190. More information regarding techniques for detecting targets and/or objects in image and video recordings may be found in U.S. patent application Ser. No. 12/972,837, “Detection of Body and Props” filed Dec. 20, 2010, incorporated herein by reference in its entirety.

In one example, structure data 198 includes structural information about objects that may be tracked. For example, a skeletal model of a human may be stored to help understand movements of the user and recognize body parts. In another example, structural information about inanimate objects, such as props, may also be stored to help recognize those objects and help understand movement.

In one example, gestures library 192 may include a collection of gesture filters, each comprising information concerning a gesture that may be performed by the skeletal model. A gesture recognition engine 190 may compare the data captured by capture device 20 in the form of the skeletal model and movements associated with it to the gesture filters in the gesture library 192 to identify when a user (as represented by the skeletal model) has performed one or more gestures. Those gestures may be associated with various controls of an application. Thus, the computing environment 120 may use the gesture recognition engine 190 to interpret movements of the skeletal model and to control operating system 196 or an application based on the movements.

In one embodiment, depth image processing and object reporting module 194 will report to operating system 196 an identification of each object detected and the position and/or orientation of the object for each frame. Operating system 196 will use that information to update the position or movement of a projected object (e.g., an avatar) or to perform an action associated with a user-interface.

More information about gesture recognizer engine 190 can be found in U.S. patent application Ser. No. 12/422,661, “Gesture Recognizer System Architecture,” filed on Apr. 13, 2009, incorporated herein by reference in its entirety. More information about recognizing gestures can be found in U.S. patent application Ser. No. 12/391,150, “Standard Gestures,” filed on Feb. 23, 2009; and U.S. patent application Ser. No. 12/474,655, “Gesture Tool” filed on May 29, 2009, both of which are incorporated by reference herein in their entirety. More information about motion detection and tracking can be found in U.S. patent application Ser. No. 12/641,788, “Motion Detection Using Depth Images,” filed on Dec. 18, 2009; and U.S. patent application Ser. No. 12/475,308, “Device for Identifying and Tracking Multiple Humans over Time,” both of which are incorporated herein by reference in their entirety.

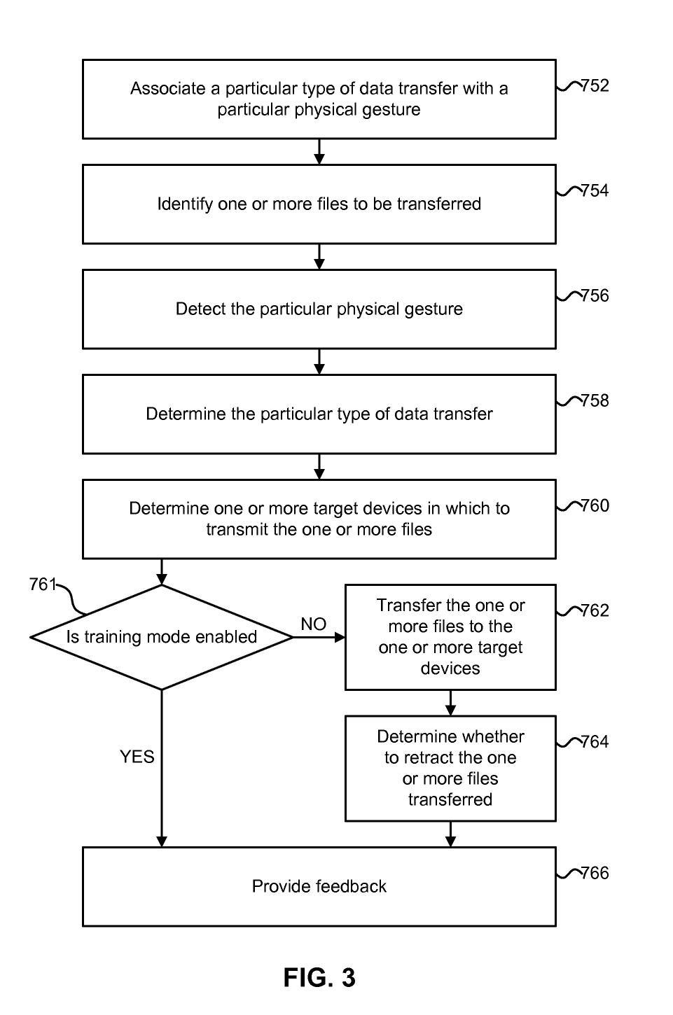

FIG. 3 is a flowchart describing one embodiment of a process for performing a data transfer from an origin device to one or more target devices in response to one or more physical gestures. The process of FIG. 3 may be performed by one or more computing devices. Each step in the process of FIG. 3 may be performed by the same or different computing devices as those used in other steps, and each step need not necessarily be performed by a single computing device. In one embodiment, the process of FIG. 3 is performed continuously by a mobile device such as mobile device 822 in FIG. 2A.

In step 752, a particular type of data transfer is associated with a particular physical gesture. A particular type of data transfer may be associated with one or more physical gestures. One or more physical gestures may map to the same particular type of data transfer. In one example, a user of an origin (or transmitting) device may select the mapping between data transfer types and the associated one or more physical gestures using a user interface on the origin device.

A particular type of data transfer may include a type that sends data to all devices within a predefined group or sends data to one or more target devices based on a particular physical gesture. In one embodiment, the particular type of data transfer sends data to all devices within a predefined group. The predefined group may include all devices listed as being paired (or grouped) with the origin device. In some embodiments, the particular type of data transfer may include a type that determines whether data is copied or moved to a particular target device. In another embodiment, the particular type of data transfer may include a type that sends data to a particular target device. The particular target device may be identified by an IP or network address, or by a cell phone or mobile device number. The particular type of data transfer may also send data to one or more electronic addresses. The one or more electronic addresses may include one or more email addresses.

The particular type of data transfer may be associated with the particular physical gesture of shaking the origin device or moving the origin device in a particular direction. Physical gestures may include combinations of horizontal motions, vertical motions, and rotation motions (e.g., hand or wrist rotation motions). The particular type of data transfer may also be associated with the particular physical gesture of pointing the origin device in the direction of a particular target device.

In one embodiment, the particular type of data transfer is associated with the particular physical gesture of pointing the origin device in the direction of a target representation. In one example, the target representation may be a visual representation of a target recipient. The visual representation may be an avatar, or other image, that is used by the target recipient to identify themselves. The visual representation may include text. The visual representation may also be a moving player representation in a computer game. A profile may be associated with the target representation that includes contact information such as an electronic address or network address for transmitting data to the target recipient. The profile may also include authentication information such as user names and/or passwords necessary for transmitting data to the target recipient.

In step 754, one or more files are identified to be transferred from an origin device. The one or more files may include audio, image, video, gaming, and/or text files. Further, the one or more files may also include instructions or commands to be executed on a target device. Although examples of the disclosed technology described herein may discuss the transfer of data including one or more files, other data units may also be used.

In one embodiment, the one or more files are identified by being present in a predefined folder (or other representation of a file system directory) or file system location. The one or more files may also be identified as those created or modified within a certain period of time within the predefined folder. In another embodiment, the one or more files are identified as those that are currently selected, being played, or being displayed on a computing device. In one example, the one or more files identified to be transferred comprise the most active content within a certain period of time of a data transfer request. For example, the one or more files identified to be transferred may comprise the highest piece of active content in a stack such as an execution or run-time stack. In another example, a user of the origin device manually selects the one or more files to be transferred (using a pointing device, gesture, or other means) prior to performing the data transfer. The user selection may be stored in a particular location on the origin device. The particular location which contains the user selection may be read by the origin device to identify the one or more files.

In step 756, the particular physical gesture is detected. In one embodiment, the particular physical gesture is detected by the origin device itself such as mobile device 822 in FIG. 2A. In another embodiment, the particular physical gesture is detected by a target detection system such as target detection and tracking system 10 in FIG. 2A. The particular physical gesture detected may comprise a hand gesture. For example, a user's hand gesture may initiate a data transfer by mimicking the firing of a handgun (e.g., by extending their index finger and contracting their thumb). The particular physical gesture detected may comprise the user shaking and then pointing and holding the origin device in the direction of the target device for a particular period of time (e.g., 5 seconds). Other gestures may also be detected and used.

In one embodiment, an accidental transfer mechanism is used to prevent accidental data transfers. The accidental transfer mechanism must be satisfied in order for a particular physical gesture to be detected. In one example, the accidental transfer mechanism includes a particular button on the origin device that must be held while performing the particular physical gesture. In another example, the accidental transfer mechanism includes a voice command that must be issued prior to performing the particular physical gesture.

In step 758, the particular type of data transfer is determined. In one embodiment, the particular type of data transfer is determined using a lookup table. The lookup table may contain entries for each detectable physical gesture and the associated mapping to a particular type of data transfer, for example, as determined by step 752 in FIG. 3. A hash table may also be used to determine the particular type of data transfer by mapping a detected particular physical gesture to the particular type of data transfer.

In step 760, one or more target devices in which to transmit the one or more files is determined. The determination of the one or more target devices may be based on the particular type of data transfer requested. In one embodiment, if the particular type of data transfer requested is to send data to all devices within a predefined group, then the one or more target devices include all devices included within the predefined group. The predefined group may be defined by pairing (or grouping) the origin device with other computing devices and placing the pairing information into a data transfer control list or a particular profile associated with a user of the origin device such as a personal, work, or gaming profile. The pairing (or grouping) of one or more computing devices with the origin device may also be used as a filter for determining the one or more target devices. For example, the one or more target devices may include only those computing devices that have been paired with the origin device. In another example, the one or more target devices may include only those computing devices that have been paired with the origin device and that are within a predefined distance of the origin device.

In some embodiments, the pairing between an origin device and one or more computing devices may be automatically determined. One process for automatically pairing devices may include the origin device automatically detecting one or more computing devices within its proximity (e.g., detecting all WiFi networks in the area), requesting and receiving positional and/or identity information (e.g., device identifiers, user names, passwords, authentication tokens, real names, and addresses) from the one or more computing devices, comparing the received identity information with information stored in a list of potential pairings (e.g., checking an electronic address book or other list of personal and/or work contacts for a match with the identity information received), sending a pairing request to one or more computing devices associated with a match, and adding the one or more computing devices associated with a match to a pairing list, a data transfer control list, or a particular profile associated with a user of the origin device such as a personal, work, or gaming profile. The list of potential pairings used by the origin device to determine whether it should be paired with another computing device may include information that allows all computing devices associated with a particular user name or authentication token to be paired with the origin device.

More information regarding automatically pairing computing devices within a proximity may be found in the following co-pending patent applications, all of which are herein incorporated by reference in their entirety: U.S. patent application Ser. No. 12/820,981, entitled “Networked Device Authentication, Pairing, and Resource Sharing,” filed Jun. 22, 1010; U.S. patent application Ser. No. 12/820,982, entitled “System for Interaction of Paired Devices,” filed Jun. 22, 2010; U.S. patent application Ser. No. 12/813,683, entitled “Proximity Network,” filed Jun. 11, 2010.

In one embodiment, the one or more target devices include only those devices paired to the origin device and in which the one or more target devices recognizes the pairing (i.e., the origin device and the one or more target devices are mutually paired). In one example, the origin device requests pairing information from one or more potential target devices prior to determining the one or more target devices. The pairing information received may include whether a potential target device is open to accepting a data transfer from the origin device.

In some embodiments, the origin device may obtain positional information regarding the one or more target devices from itself and/or another computing device such as target detection and tracking system 10 in FIG. 2A. The position information may be used to determine the physical location of the origin device and/or the physical locations of the one or more target devices. In one embodiment, the origin device and/or one or more target devices may include a Global Positioning System (GPS) receiver for receiving GPS location information. The GPS location information may be used to determine the physical location of the origin device and one or more target devices. Pseudolite technology may also be used in the same manner that the pure GPS technology is used. In another embodiment, a wireless technology utilizing infrared (IR), radio frequency (RF), or other wireless communication signals may be used to determine the relative positions of computing devices via direction finding. Direction finding refers to the determination of the direction from which a signal was received. In one example, direction finding may involve a directional antenna or a wireless signal detector that is more sensitive to wireless signals in certain directions than in others. The positions of computing devices may also be determined via triangulation. Triangulation is a process by which the location of a transmitter (e.g., the origin device or a target device) can be determined by measuring either the radial distance, or the direction, of a received signal from two or more different locations.

The origin device may perform a direct data transfer or an indirect data transfer. A direct data transfer is one where the origin device transmits data directly to one or more target devices without the use of an intermediary computing device. An indirect data transfer is one where the origin device utilizes an intermediary device in order to transmit data to one or more target devices. In one example, the intermediary device obtains one or more electronic addresses associated with the one or more target devices from a profile prior to transmitting data to the one or more target devices. Both direct and indirect data transfers may be performed over wired and/or wireless connections (e.g., Wi-Fi or Bluetooth® connections) between computing devices.

In one embodiment, if the particular type of data transfer requested is to send data to a particular target device based on the direction of motion of an origin device, then the one or more target devices includes the particular target device identified to be in the direction of motion and closest to the origin device. If no target device is identified to be in the direction of motion, then the target device identified to be closest to the direction of motion may be identified as the particular target device. The direction of motion may be specified as a vector in a three dimensional space. The direction of motion may also be represented by a vector in a two dimensional space or a set of one or more vectors in a three dimensional space. The process of identifying the particular target device closest to the direction of motion may take into account the proximity of the particular target device to the origin device.

In one embodiment, the direction of motion of an origin device is determined by the origin device itself. In one example, the origin device is an active object that includes a three-axis accelerometer and a three-axis gyroscope in order to obtain acceleration and orientation information. The acceleration and orientation information may be used to determine the direction of motion for the origin device. An origin device may include a magnetometer for calibrating the origin device's orientation against the Earth's magnetic field. An origin device may also include a timing circuit (e.g., a digital counter that increments at a fixed frequency) for determining an elapsed time from a first point in time to a subsequent second point in time. Through the use of accelerometers, gyroscopes, magnetometers, and timing circuits, an origin device may determine not only the direction of motion for a particular physical motion, but also the distance traveled by the origin device during the particular physical motion. For example, assuming a constant acceleration and non-relativistic velocity, Newtonian equations of motion may be used to estimate the distance traveled by the origin device given information regarding acceleration, initial velocity, and elapsed time.

In another embodiment, the direction of motion of an origin device is determined by a target detection and tracking system such as target detection and tracking system 10 in FIG. 2A. The direction of motion may be determined from depth images associated with the beginning and ending of a particular motion. A first depth image associated with the beginning of a particular motion may be used to determine a starting point in a three dimensional space for the origin device (e.g., via pattern or object recognition). A second depth image associated with the ending of a particular motion may be used to determine an ending point in the three dimensional space for the origin device. The direction of motion may be represented as the vector in the three dimensional space associated with the starting point and the ending point for the particular motion.

If the physical locations of the origin device and one or more computing devices are known (e.g., via GPS), then the one or more target devices in the direction of motion may be determined by considering the location of the origin device as a starting point and finding all the computing devices either directly in the direction of motion or within an error tolerance (e.g., plus or minus 5 degrees from the direction of motion).

If the physical locations are not known, then the relative positions of the origin device and one or more computing devices may be used to determine the one or more target devices in the direction of motion. In one example, time-of-flight analysis may be used to determine a first distance between the origin device and another computing device at the beginning of a particular physical motion, and a second distance between the origin device and the other computing device at the end of the particular physical motion. One method for determining whether the other computing device is in the direction of motion given the first distance and the second distance is to subtract the first distance from the second distance. If the result is a positive number, then the other computing device may be deemed in the direction of motion. Another method for determining whether the other computing device is in the direction of motion is to consider the distance traveled by the origin device during the particular physical motion. If the other computing device is exactly in the direction of motion, then the first distance will be equal to the second distance plus the distance traveled during the particular physical motion. Further, once all three distances, which comprise three sides of a triangle formed by the other computing device and the beginning and ending points of the particular physical motion, are determined, then trigonometric functions and relationships (e.g., the law of sines) may be used to determine the angle between the direction of motion and the direction to the other computing device. If the angle is less than a certain threshold (e.g., 5 degrees), then the other computing device may be deemed to be within the direction of motion and thus one of the one or more target devices.

In one embodiment, a target detection and tracking system determines the direction of motion for the origin device and transmits information regarding the direction of motion to the origin device. As described above, the direction of motion for the origin device may be determined by considering depth images associated with the beginning and ending of a particular motion. The locations of other computing devices may be determined using pattern or object recognition on a depth image associated with the ending of the particular motion. Given the direction of motion of the origin device and the locations of other computing devices within the field of view, the target detection and tracking system may determine whether the other computing devices are either directly in the direction of motion or within an error tolerance (e.g., plus or minus 5 degrees from the direction of motion). Further, the target detection and tracking system may determine if and where the direction of motion intersects a plane associated with a display device such as audiovisual device 16 in FIG. 2A. Because the target detection and tracking system knows where visual representations are located on the display device, it may also determine if one of the visual representations is within the direction of motion and thus a selected target representation.

If the particular type of data transfer requested is an indirect data transfer to a particular target device based on the direction of motion of an origin device, then the one or more target devices includes the particular target device associated with a target representation identified to be closest to the direction of motion (i.e., the target representation is being selected, and not the particular target device itself). In some examples, the target representation may be represented by an image of the particular target device or an image associated with a user of the particular target device. The target representation may be associated with one or more target devices and/or associated with a profile containing contact information for one or more target devices.

In one embodiment, a target detection and tracking system determines the direction of motion for the origin device, determines the selected target representation in the direction of motion, receives profile information regarding the selected target representation from an application server, and transmits the profile information to the origin device. The profile information regarding the selected target may include contact information and/or positional information.

In another embodiment, a target detection and tracking system determines the direction of motion for the origin device, determines the selected target representation in the direction of motion, receives one or more files from the origin device, receives profile information regarding the selected target representation from an application server, and transmits the one or more files to one or more target computing devices based on the profile information. The profile information regarding the selected target representation may include contact information and/or positional information.

In step 761, it is determined whether a training mode is enabled. A training mode may be entered by a user of an origin device by issuing a training mode instruction or selecting a training module from a graphical user interface associated with the origin device. If a training mode is determined to be enabled, then steps 762 and 764 are bypassed because a real data transfer is not being requested. In one embodiment, if a training mode is enabled, then steps 754 and 758 may be omitted. If the training mode is determined to be not enabled, then a real data transfer is performed in step 762.

In one embodiment of a process for training a user of an origin device to utilize the process of FIG. 3, the user of the origin device may enable a training mode causing the origin device to run a training module. User training utilizing the training module may be performed prior to performing an actual data transfer from the origin device to one or more target devices in response to one or more physical gestures. In one example, the training module provides feedback to the user of the origin device regarding when particular physical gestures are being performed. In another example, the training module may graphically display the one or more target devices selected after a particular physical gesture is performed in order to help train the user how to accurately perform a desired particular physical gesture. The training module feedback provided to the user of the origin device may be performed, for example, in step 766.

In step 762, the identified one or more files are transferred to the one or more target devices. In one embodiment, the data transfer takes place over a wireless connection. In one example, an FTP or HTTP connection is established over a wireless local area network. The one or more files may be transferred first to an intermediary computing device, such as application server 250 in FIG. 1, and then redirected to the one or more target devices. A connection to the intermediary computing device may be made via the cloud. The one or more files may also be transferred first to a local computing device, such as gaming console 12 in FIG. 2A, and then redirected to the one or more target devices.

In one embodiment, an origin device may perform a direct data transfer to a particular target device by first obtaining the contact information for the particular target device from a profile. In one example, the origin device may obtain the contact information by requesting and receiving the contact information from the source of the profile from an intermediary computing device such as gaming console 12 in FIG. 2A. In another embodiment, an origin device may perform an indirect data transfer to a particular target device by transmitting the one or more files to an intermediary computing device such as gaming console 12, which then redirects the one or more files to the particular target device.

The decision to perform either a direct or indirect data transfer may be based on the detected particular physical gesture. For example, the decision to perform either a direct or indirect data transfer may be based on the size of the one or more files and available bandwidth. In another example, the decision to perform either a direct or indirect data transfer may be based on whether the one or more files are considered secure files or otherwise require a high degree of security. In the case that the one or more files require a high degree security, a direct transfer from the origin device to a particular target device may be preferred.

In step 764, it is determined whether to retract the one or more files transferred. In the event that an accidental data transfer has been performed, a user of an origin device may retract the one or more files transferred in error. In one embodiment, data is retracted (i.e., deleted from the one or more target devices) if a particular button located on the origin device is pressed within a certain period of time after the data to be retracted was transferred. In one embodiment, data is retracted if a retraction gesture or motion is performed within a certain period of time after the data to be retracted was transferred. In another embodiment, the retraction gesture or motion may be performed prior to completion of the data transfer for the one or more files. The retraction gesture may be detected by the origin device itself or by a target detection and tracking system such as target detection and tracking system 10 in FIG. 2A. In one example, subsequent to detecting a retraction gesture, target detection and tracking system 10 may transmit a retraction instruction to the origin device or otherwise provide notification to the origin device that a retraction gesture has been detected.

In step 766, feedback is provided to the user of the origin device. In one embodiment, feedback is provided regarding the type of data transfer performed. For example, the feedback may include a specific sound in response to the type of data transfer performed (e.g., one beep for a data transfer to a particular target device, and two beeps for a data transfer to more than one target device). Feedback may also be provided regarding whether the data transfers were successful. For example, if a target device does not accept a data transfer, then an error message may be reported and/or displayed to the user. A data transfer notification such as an email or other electronic message may also be provided to the user of the origin device. In one embodiment, feedback is provided via a display on the origin device regarding the particular physical gesture performed and/or the one or more target devices selected by the particular physical gesture.

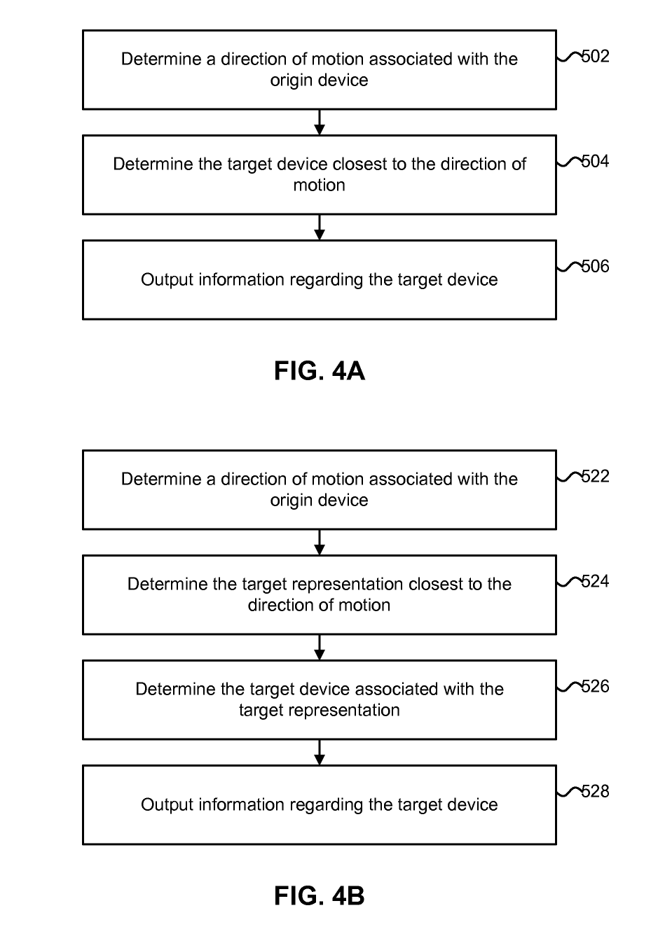

FIG. 4A is a flowchart describing one embodiment of a process for determining one or more target devices in preparation for a direct data transfer. The process described in FIG. 4A is only one example of a process for implementing step 760 in FIG. 3. The process of FIG. 4A may be performed by one or more computing devices. Each step in the process of FIG. 4A may be performed by the same or different computing devices as those used in other steps, and each step need not necessarily be performed by a single computing device. In one embodiment, the process of FIG. 4A is performed by a mobile device. In another embodiment, the process of FIG. 4A is performed by a target detection and tracking system.

In step 502, a direction of motion associated with the origin device is determined. In one example, the origin device's direction of motion is determined using acceleration and orientation information generated by the origin device itself. In another example, the origin device's direction of motion is determined using a target detection and tracking system, such as target detection and tracking system 10 in FIG. 2A. The target detection and tracking system may track the movement of the origin device within a captured three dimensional space and generate motion vectors associated with the movement of the origin device. In step 504, the target device closest to the direction of motion is determined. In one example, a centroid (i.e., the geometric center) or center of mass for the target device may be used in calculating the distance between the target device and the one or more vectors representing the direction of motion. The closest target device may be the target device with the least distance to the vector representing the direction of motion. In step 506, information regarding the target device is outputted. In one example, contact information regarding the target device is transmitted from a target detection and tracking system to the origin device.

FIG. 4B is a flowchart describing one embodiment of a process for determining one or more target devices in preparation for an indirect data transfer. The process described in FIG. 4B is only one example of a process for implementing step 760 in FIG. 3. The process of FIG. 4B may be performed by one or more computing devices. Each step in the process of FIG. 4B may be performed by the same or different computing devices as those used in other steps, and each step need not necessarily be performed by a single computing device. In one embodiment, the process of FIG. 4B is performed by a gaming console. In another embodiment, the process of FIG. 4B is performed by a target detection and tracking system.

In step 522, a direction of motion associated with the origin device is determined. In one example, the origin device's direction of motion is determined using a target detection and tracking system. The target detection and tracking system may track the movement of the origin device within a captured three dimensional space and generate one or more motion vectors associated with the movement of the origin device. In step 524, the target representation closest to the direction of motion is determined. In one example, a centroid (i.e., the geometric center) or center of mass for the target representation may be used in calculating the distance between the target representation and the one or more vectors representing the direction of motion. The closest target representation may be the target representation with the least distance to the direction of motion. In step 526, the target device associated with the target representation is determined. In one example, contact information contained within a profile associated with the target representation identifies the target device. In step 528, information regarding the target device is outputted. In one example, the contact information regarding the target device is used by a target detection and tracking system to transfer data to the target device.

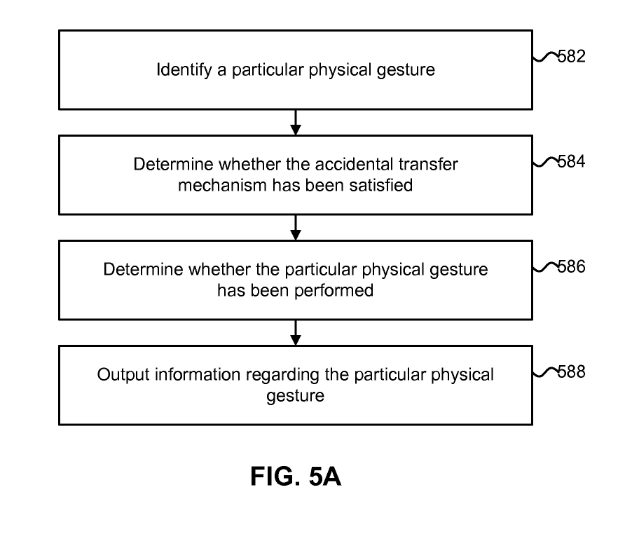

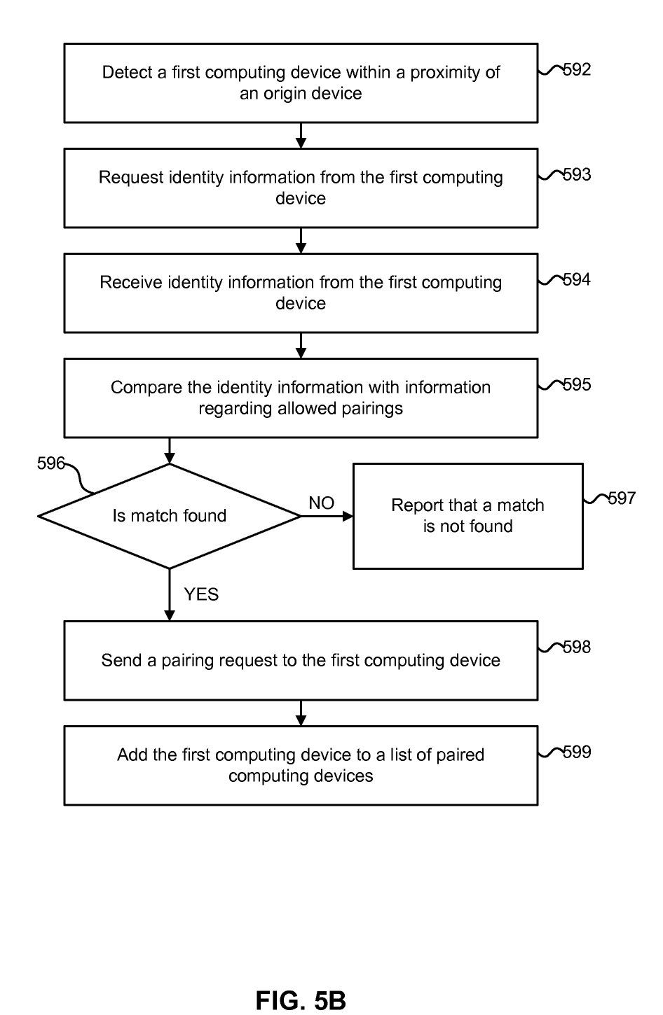

FIG. 5A is a flowchart describing one embodiment of a process for detecting a particular physical gesture. The process described in FIG. 5A is only one example of a process for implementing step 756 in FIG. 3. The process of FIG. 5A may be performed by one or more computing devices. Each step in the process of FIG. 5A may be performed by the same or different computing devices as those used in other steps, and each step need not necessarily be performed by a single computing device. The process of FIG. 5A may be performed continuously by an origin device or a target detection and tracking system.

In step 582, a particular physical gesture is identified. In one example, the particular physical gesture includes the physical movement of an origin device. The particular physical gesture may be identified by the origin device itself or by a target detection and tracking system which is capable of detecting the physical movement of the origin device. In step 584, it is determined whether an accidental transfer mechanism has been satisfied. In one example, the accidental transfer mechanism may be satisfied by selecting a particular button on the origin device or by issuing a particular voice command prior to performing the particular physical gesture. In step 586, it is determined whether the particular physical gesture has been performed. In one example, the particular physical gesture is deemed to have been performed only if both the particular physical gesture has been identified and the accidental transfer mechanism has been satisfied. In step 588, information regarding the particular physical gesture is outputted. In one example, a unique gesture identifier associated with the particular physical gesture is transmitted to one or more computing devices performing the process of FIG. 3.

FIG. 5B is a flowchart describing one embodiment of a process for automatically pairing one or more computing devices. The process of FIG. 5B may be performed by one or more computing devices. Each step in the process of FIG. 5B may be performed by the same or different computing devices as those used in other steps, and each step need not necessarily be performed by a single computing device. The process of FIG. 5B may be performed by an origin device.

The pairing of one or more computing devices with the origin device (either manually or automatically) may be used as a filter for determining the one or more target devices. For example, the one or more target devices may include only those computing devices that have been paired with the origin device.

In step 592, a first computing device is detected within a proximity of an origin device. In one example, a wireless network associated with the first computing device is detected by the origin device. The proximity of the first computing device may be constrained to a specified physical distance from the origin device. In step 593, identity information is requested from the first computing device. The identity information may be requested via the wireless network associated with the first computing device. In step 594, identity information is received from the first computing device. The identity information may include device identifiers, user names, passwords, authentication tokens, real names, and addresses. In step 595, the identity information received from the first computing device is compared with information regarding allowed pairings. In one example, the origin device searches a list of potential pairings for matches related to the identity information. The list of potential pairings may comprise an electronic address book, in which case, the origin device may compare the entries in the electronic address book with the identity information. The list of potential pairings may also provide rules that allow all computing devices associated with a particular user name or authentication token to be paired with the origin device.

In step 596, it is determined whether a match was been found. If a match is found, then the first computing device is paired by adding it to a list of paired computing devices in step 599. If a match is not found, then the first computing device is not paired with the origin device. In step 597, it is reported that a match has not been found. In step 598, a pairing request is sent to the first computing device. In some embodiments, step 598 may be omitted. In step 599, the first computing device is added to a list of paired computing devices. The list of paired computing devices may comprise a data transfer control list or a particular profile associated with a user of the origin device such as a personal, work, or gaming profile.

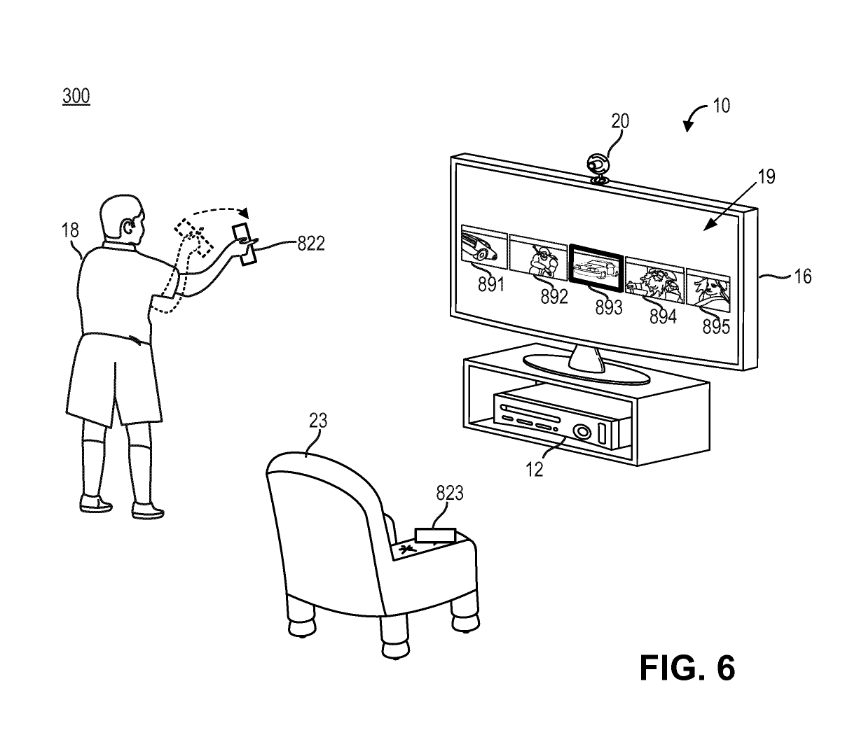

FIG. 6 depicts one embodiment of an indirect data transfer to a particular target device utilizing the networked computer environment of FIG. 2A. FIG. 6 includes user interface 19 presented to user 18. The user interface includes images 891-895. In one embodiment, the images 891-895 represent players in a gaming application (e.g., players in an online game of bridge or poker). As depicted in FIG. 6, the user 18 moves their arm from a starting position (broken line) to an ending position (solid line) in the direction of image 893 and holds mobile device 822 in the direction of image 893. By performing the particular physical gesture of moving and holding an origin device in the direction of image 893, target detection and tracking system 10 is able to detect the direction of motion and determine that image 893 is selected by user 18 for use in a data transfer.

In one embodiment, image 893 represents a particular person (i.e., the car of image 893 is how the particular person identifies himself or herself to user 18). The image 893 may be associated with a profile that includes contact information for a particular target device such as mobile device 823 in FIG. 2A. Therefore, by selecting image 893 (e.g., by pointing mobile device 822 at image 893), the user 18 may initiate an indirect data transfer from mobile device 822 (i.e., the origin device) through target detection and tracking system 10 to mobile device 823 (i.e., the particular target device) because image 893 (i.e., the target representation) is associated with a profile including contact information for mobile device 823. With an indirect data transfer, neither the user 18 nor the origin device need to have knowledge of where a particular target device is located or need to obtain contact information for the particular target device in order to perform the data transfer. Further, over time, the particular person may update their profile with new contact information regarding the particular target device. For example, the particular person may originally want indirect data transfers to be sent to their home computer, but then update their profile so that subsequent indirect data transfers are sent to their mobile device.

Referring to FIG. 6, a profile associated with image 893 may be stored locally on gaming console 12 or remotely, for example, on an application server such as application server 250 in FIG. 1. The profile may include authentication information and contact information for the particular person represented by image 893. The authentication information may include user names and passwords. The contact information may include IP, network, and email addresses. The profile may also include information regarding the directory locations where data may be accepted by a target device. Information contained within the profile such as authentication information and/or contact information may be encrypted.

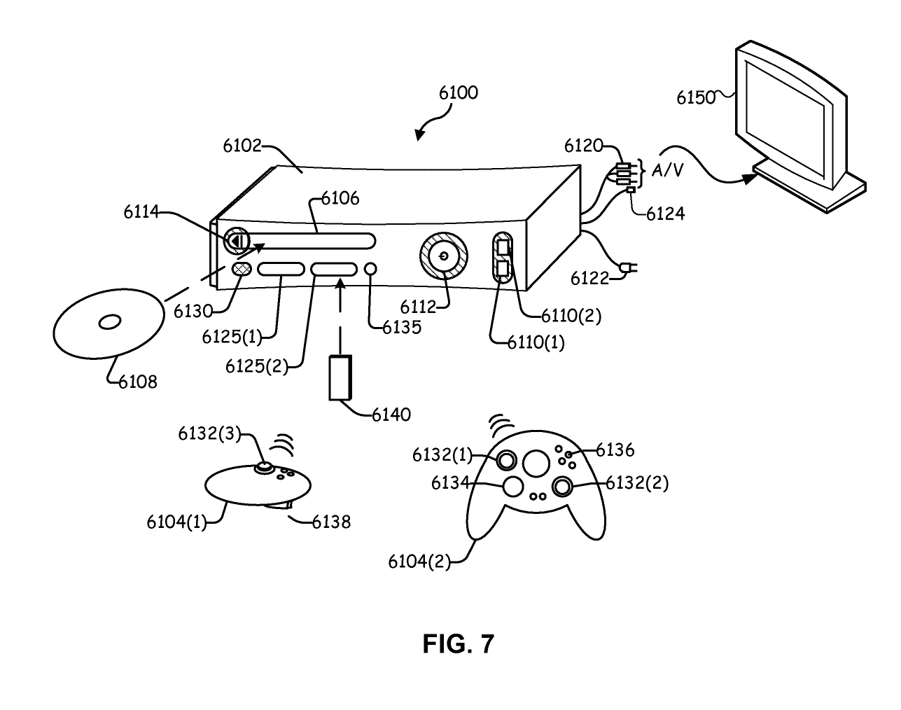

The disclosed technology may be used with various computing systems. FIGS. 7-10 provide examples of various computing systems that can be used to implement embodiments of the disclosed technology.

FIG. 7 depicts one embodiment of a gaming and media system 6100. The following discussion of FIG. 7 is intended to provide a brief, general description of a suitable environment in which the concepts presented herein may be implemented. For example, the apparatus of FIG. 7 is one example of game console 240 in FIG. 1 or gaming console 12 in FIG. 2A. As shown in FIG. 7, gaming and media system 6100 includes a game and media console (hereinafter “console”) 6102. In general, console 6102 is one type of computing system, as will be further described below. Console 6102 is configured to accommodate one or more wireless controllers, as represented by controllers 6104(1) and 6104(2). Console 6102 is equipped with an internal hard disk drive (not shown) and a portable media drive 6106 that support various forms of portable storage media, as represented by optical storage disc 6108. Examples of suitable portable storage media include DVD, CD-ROM, and game discs. Console 6102 also includes two memory unit card receptacles 6125(1) and 6125(2), for receiving removable flash-type memory units 6140. A command button 6135 on console 6102 enables and disables wireless peripheral support.

As depicted in FIG. 7, console 6102 also includes an optical port 6130 for communicating wirelessly with one or more devices and two USB (Universal Serial Bus) ports 6110(1) and 6110(2) to support a wired connection for additional controllers, or other peripherals. In some implementations, the number and arrangement of additional ports may be modified. A power button 6112 and an eject button 6114 are also positioned on the front face of game console 6102. Power button 6112 is selected to apply power to the game console, and can also provide access to other features and controls, and eject button 6114 alternately opens and closes the tray of a portable media drive 6106 to enable insertion and extraction of a storage disc 6108.

Console 6102 connects to a television or other display (such as monitor 6150) via A/V interfacing cables 6120. In one implementation, console 6102 is equipped with a dedicated A/V port (not shown) configured for content-secured digital communication using A/V cables 6120 (e.g., A/V cables suitable for coupling to a High Definition Multimedia Interface “HDMI” port on a high definition monitor 6150 or other display device). A power cable 6122 provides power to the game console. Console 6102 may be further configured with broadband capabilities, as represented by a cable or modem connector 6124 to facilitate access to a network, such as the Internet. The broadband capabilities can also be provided wirelessly, through a broadband network such as a wireless fidelity (Wi-Fi) network.

Each controller 6104 is coupled to console 6102 via a wired or wireless interface. In the illustrated implementation, the controllers 6104(1) and 6104(2) are USB-compatible and are coupled to console 6102 via a wireless or USB port 6110. Console 6102 may be equipped with any of a wide variety of user interaction mechanisms. For example, in FIG. 7, controller 6104(2) is equipped with two thumbsticks 6132(1) and 6132(2), a D-pad 6134, and buttons 6136, and controller 6104(1) is equipped with thumbstick 6132(3) and triggers 6138. These controllers are merely representative, and other known gaming controllers may be substituted for, or added to, those shown in FIG. 7.

In one implementation, a memory unit (MU) 6140 may be inserted into controller 6104(2) to provide additional and portable storage. Portable MUs enable users to store game parameters for use when playing on other consoles. In one embodiment, each controller is configured to accommodate two Mus 6140, although more or less than two MUs may also be employed. In another embodiment, a Universal Serial Bus (USB) flash memory storage may also be inserted into controller 6104(2) to provide additional and portable storage.

Gaming and media system 6100 is generally configured for playing games stored on a memory medium, as well as for downloading and playing games, and reproducing pre-recorded music and videos, from both electronic and hard media sources. With the different storage offerings, titles can be played from the hard disk drive, from an optical disk media (e.g., 6108), from an online source, or from MU 6140.

During operation, console 6102 is configured to receive input from controllers 6104(1) and 6104(2) and display information on display 6150. For example, console 6102 can display a user interface on display 6150 to allow a user to perform the operations of the disclosed technology discussed herein.

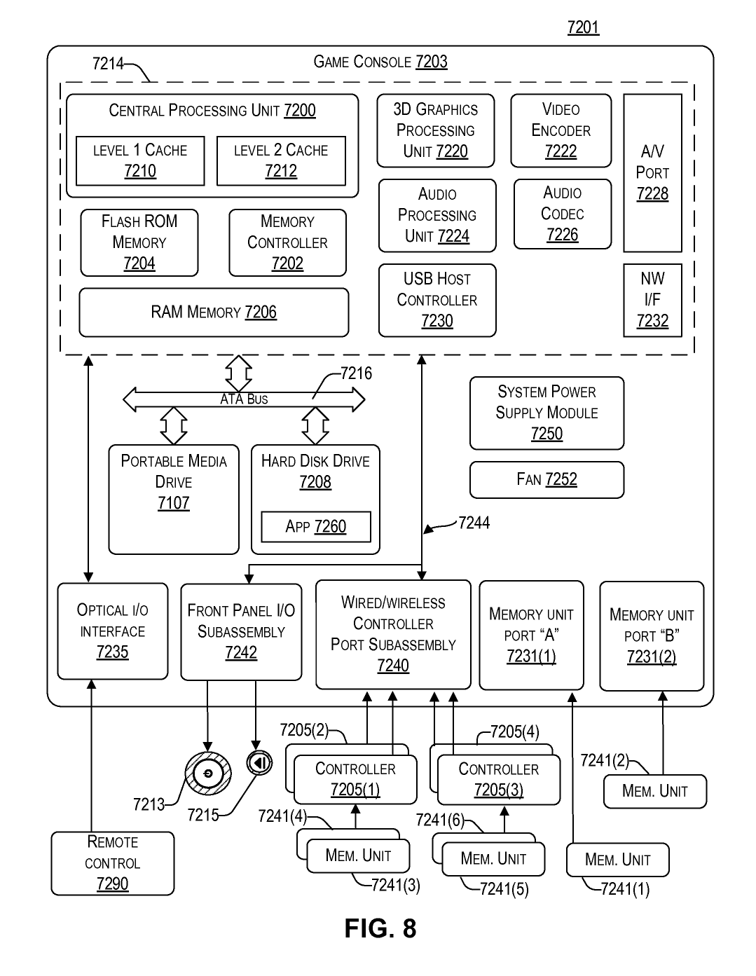

FIG. 8 is a block diagram of an embodiment of a gaming and media system 7201 (such as system 6100). Console 7203 has a central processing unit (CPU) 7200, and a memory controller 7202 that facilitates processor access to various types of memory, including a flash Read Only Memory (ROM) 7204, a Random Access Memory (RAM) 7206, a hard disk drive 7208, and portable media drive 7107. In one implementation, CPU 7200 includes a level 1 cache 7210 and a level 2 cache 7212, to temporarily store data and hence reduce the number of memory access cycles made to the hard drive 7208, thereby improving processing speed and throughput.

CPU 7200, memory controller 7202, and various memory devices are interconnected via one or more buses (not shown). The one or more buses might include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus.

In one implementation, CPU 7200, memory controller 7202, ROM 7204, and RAM 7206 are integrated onto a common module 7214. In this implementation, ROM 7204 is configured as a flash ROM that is connected to memory controller 7202 via a PCI bus and a ROM bus (neither of which are shown). RAM 7206 is configured as multiple Double Data Rate Synchronous Dynamic RAM (DDR SDRAM) modules that are independently controlled by memory controller 7202 via separate buses (not shown). Hard disk drive 7208 and portable media drive 7107 are shown connected to the memory controller 7202 via the PCI bus and an AT Attachment (ATA) bus 7216. However, in other implementations, dedicated data bus structures of different types may also be applied in the alternative.

A three-dimensional graphics processing unit 7220 and a video encoder 7222 form a video processing pipeline for high speed and high resolution (e.g., High Definition) graphics processing. Data are carried from graphics processing unit 7220 to video encoder 7222 via a digital video bus (not shown). An audio processing unit 7224 and an audio codec (coder/decoder) 7226 form a corresponding audio processing pipeline for multi-channel audio processing of various digital audio formats. Audio data are carried between audio processing unit 7224 and audio codec 7226 via a communication link (not shown). The video and audio processing pipelines output data to an A/V (audio/video) port 7228 for transmission to a television or other display. In the illustrated implementation, video and audio processing components 7220-7228 are mounted on module 7214.

FIG. 8 shows module 7214 including a USB host controller 7230 and a network interface 7232. USB host controller 7230 is in communication with CPU 7200 and memory controller 7202 via a bus (not shown) and serves as host for peripheral controllers 7205(1)-7205(4). Network interface 7232 provides access to a network (e.g., Internet, home network, etc.) and may be any of a wide variety of various wire or wireless interface components including an Ethernet card, a modem, a wireless access card, a Bluetooth® module, a cable modem, and the like.

In the implementation depicted in FIG. 8, console 7203 includes a controller support subassembly 7240 for supporting four controllers 7205(1)-7205(4). The controller support subassembly 7240 includes any hardware and software components needed to support wired and wireless operation with an external control device, such as for example, a media and game controller. A front panel I/O subassembly 7242 supports the multiple functionalities of power button 7213, the eject button 7215, as well as any LEDs (light emitting diodes) or other indicators exposed on the outer surface of console 7203. Subassemblies 7240 and 7242 are in communication with module 7214 via one or more cable assemblies 7244. In other implementations, console 7203 can include additional controller subassemblies. The illustrated implementation also shows an optical I/O interface 7235 that is configured to send and receive signals (e.g., from remote control 7290) that can be communicated to module 7214.

MUs 7241(1) and 7241(2) are illustrated as being connectable to MU ports “A” 7231(1) and “B” 7231(2) respectively. Additional MUs (e.g., MUs 7241(3)-7241(6)) are illustrated as being connectable to controllers 7205(1) and 7205(3), i.e., two MUs for each controller. Controllers 7205(2) and 7205(4) can also be configured to receive MUs (not shown). Each MU 7241 offers additional storage on which games, game parameters, and other data may be stored. Additional memory devices, such as portable USB devices, can be used in place of the MUs. In some implementations, the other data can include any of a digital game component, an executable gaming application, an instruction set for expanding a gaming application, and a media file. When inserted into console 7203 or a controller, MU 7241 can be accessed by memory controller 7202. A system power supply module 7250 provides power to the components of gaming system 7201. A fan 7252 cools the circuitry within console 7203.

An application 7260 comprising machine instructions is stored on hard disk drive 7208. When console 7203 is powered on, various portions of application 7260 are loaded into RAM 7206, and/or caches 7210 and 7212, for execution on CPU 7200. Other applications may also be stored on hard disk drive 7208 for execution on CPU 7200.

Gaming and media system 7201 may be operated as a standalone system by simply connecting the system to a monitor, a television, a video projector, or other display device. In this standalone mode, gaming and media system 7201 enables one or more players to play games or enjoy digital media (e.g., by watching movies or listening to music). However, with the integration of broadband connectivity made available through network interface 7232, gaming and media system 7201 may further be operated as a participant in a larger network gaming community.

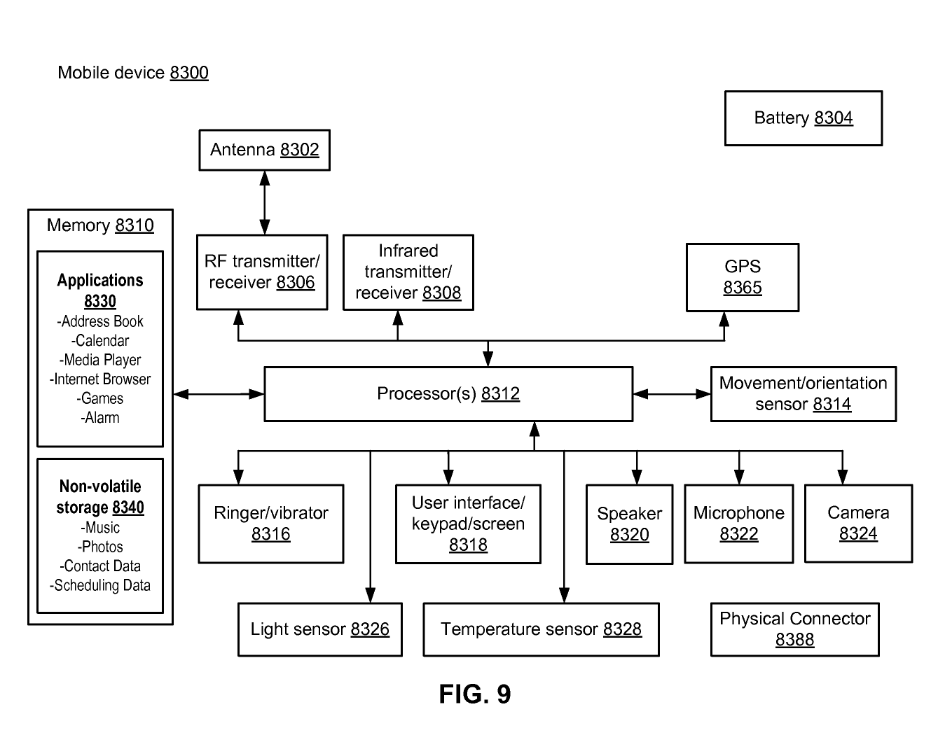

FIG. 9 is a block diagram of one embodiment of a mobile device 8300. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

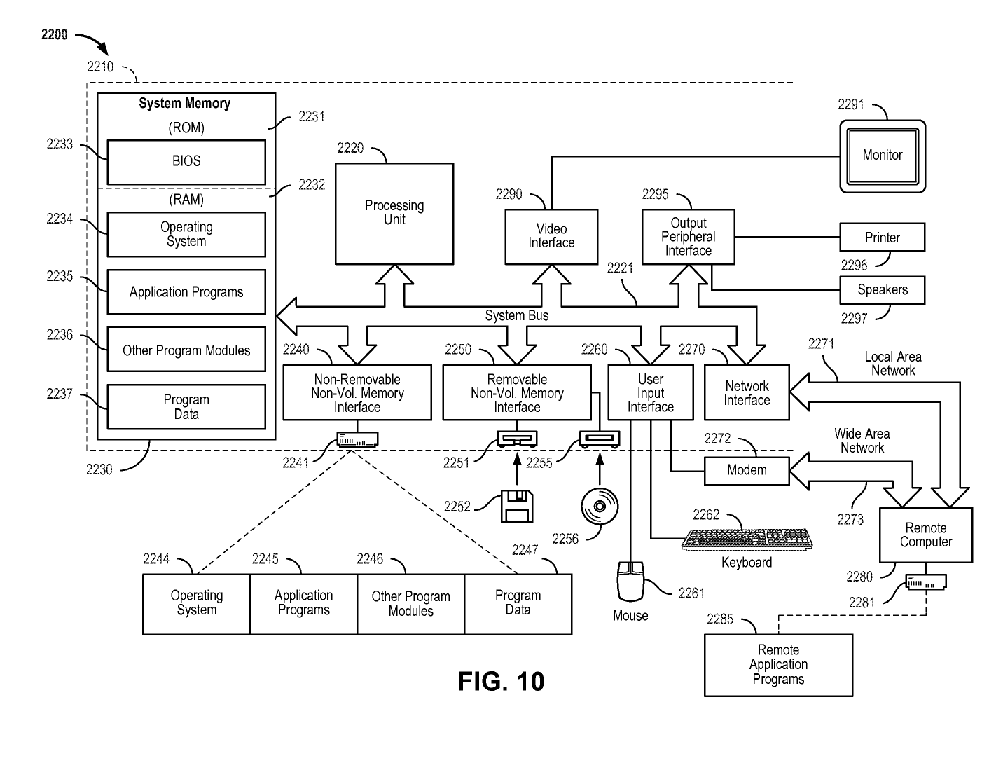

FIG. 10 is a block diagram of an embodiment of a computing system environment 2200. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. By way of example, and not limitation, FIG. 10 illustrates operating system 2234, application programs 2235, other program modules 2236, and program data 2237.

The computer 2210 may also include other removable/non-removable, volatile/nonvolatile computer storage media. By way of example only, FIG. 10 illustrates a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media discussed above and illustrated in FIG. 10, provide storage of computer readable instructions, data structures, program modules and other data for the computer 2210. In FIG. 10, for example, hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210, although only a memory storage device 2281 has been illustrated in FIG. 10. The logical connections depicted in FIG. 10 include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. By way of example, and not limitation, FIG. 10 illustrates remote application programs 2285 as residing on memory device 2281. It will be appreciated that the network connections shown are exemplary and other means of establishing a communications link between the computers may be used.

The disclosed technology is operational with numerous other general purpose or special purpose computing system environments or configurations. Examples of well-known computing systems, environments, and/or configurations that may be suitable for use with the technology include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for transferring data, comprising:
associating a particular type of data transfer with a particular physical gesture, the particular physical gesture includes a physical motion of an origin computing device;
identifying one or more files to be transferred from the origin computing device;
automatically detecting the particular physical gesture;
determining the particular type of data transfer based on the step of automatically detecting and the step of associating;
automatically determining one or more target computing devices; and
transferring the one or more files to the one or more target computing devices.

2. The method of claim 1, wherein:
the step of automatically determining one or more target computing devices includes automatically determining a direction of motion associated with the physical motion of the origin computing device; and
the step of automatically determining one or more target computing devices includes automatically identifying one or more target computing devices in the direction of motion.

3. The method of claim 2, wherein:
the step of automatically determining one or more target computing devices includes automatically identifying a selected target representation in the direction of motion and acquiring profile information associated with the selected target representation, the profile information includes contact information for the one or more target computing devices.

4. The method of claim 3, wherein:
the selected target representation includes a visual representation of a target recipient.

5. The method of claim 2, wherein:
the step of identifying one or more files to be transferred from an origin computing device includes determining the one or more files being displayed on the origin device.

6. The method of claim 2, wherein:
the particular type of data transfer includes sending the one or more files to a particular target device.

7. The method of claim 2, wherein:
the step of identifying one or more files to be transferred from an origin computing device includes determining the one or more files located within a particular file system directory; and
the particular type of data transfer includes sending the one or more files to all devices within a predefined group.

8. The method of claim 2, wherein:
the origin computing device is an active object.

9. The method of claim 2, wherein:
the step of automatically detecting the particular physical gesture includes determining whether an accidental transfer mechanism has been satisfied.

10. The method of claim 2, wherein:
the step of automatically determining one or more target computing devices is performed by a target detection and tracking system, the target detection and tracking system processes one or more depth images, the one or more depth images include one or more images of the particular physical gesture associated with the origin computing device.

11. The method of claim 2, further comprising:
retracting the one or more files.

12. The method of claim 2, further comprising:
automatically pairing one or more computing devices with the origin computing device, the one or more computing devices are in proximity with the origin device at the time the step of automatically pairing is performed, the one or more target computing devices include the one or more computing devices, the step of automatically pairing is performed prior to the step of automatically detecting the particular physical gesture.

13. An electronic device for transferring data, comprising:
a depth sensing camera, the depth sensing camera captures a first depth image, the first depth image includes an image of an origin computing device; and
one or more processors, the one or more processors in communication with the depth sensing camera, the one or more processors determine a direction of motion associated with the origin computing device, the one or more processors identify a selected target representation in the direction of motion, the one or more processors receive one or more files from the origin computing device, the one or more processors transfer the one or more files to a particular target device associated with the selected target representation.

14. The electronic device of claim 10, wherein:
the selected target representation is associated with a profile, the profile includes contact information for the particular target device.

15. The electronic device of claim 10, wherein:
the selected target representation includes a visual representation.

16. One or more storage devices containing processor readable code for programming one or more processors to perform a method comprising the steps of:
identifying one or more files to be transferred from an origin computing device;
automatically detecting a particular physical gesture, the particular physical gesture includes a physical motion of the origin computing device;
determining the particular type of data transfer based on the step of automatically detecting;
automatically determining one or more target computing devices, the step of automatically determining one or more target computing devices includes automatically determining a direction of motion associated with the physical motion of the origin computing device, the step of automatically determining one or more target computing devices includes automatically identifying a selected target representation in the direction of motion, the selected target representation is associated with a profile, the profile includes contact information for the one or more target computing devices, the contact information includes at least one electronic address; and
transferring the one or more files to the one or more target computing devices, the step of transferring includes transmitting data to the at least one electronic address.

17. The one or more storage devices of claim 16, wherein:
the selected target representation includes a visual representation of a target recipient, the visual representation of the target recipient is an avatar.

18. The one or more storage devices of claim 17, wherein:
the step of identifying one or more files to be transferred from an origin computing device includes determining the one or more files located within a particular file system directory.

19. The one or more storage devices of claim 16, wherein:
the origin computing device is an active object.

20. The one or more storage devices of claim 16, wherein:
the step of detecting the particular physical gesture includes determining whether an accidental transfer mechanism has been satisfied.
